(19) United States
(12) Patent Application Publication
(10) Pub. No.: US 2023/0129596 A1
(43) Pub. Date: Apr. 27, 2023

(54) SYSTEMS AND METHODS COMPRISING SMART COMPONENTS

(71) Applicant: BASF SE, Ludwigshafen am Rhein (DE)

(72) Inventors: Victor Oh, North Wales, PA (US); Robert Armstrong, Wyandotte, MI (US)

(21) Appl. No.: 17/904,164

(22) PCT Filed: Feb. 19, 2021
(86) PCT No.: PCT/US2021/018764

§ 371 Date: Aug. 12, 2022

Related U.S. Application Data
(60) Provisional application No. 62/979,530, filed on Feb. 21, 2020.

(51) Int. Cl. G01M 5/00; G01L 1/14

(52) U.S. Cl. CPC G01M 5/0033; G01L 1/146; G01M 5/0083; B62D 33/046

(57) ABSTRACT

Systems and methods are disclosed for real time monitoring and recording of events related to the performance and structural integrity of composite panels used in structural components of a trailer and their effective use as an insulating material and structural panel. The systems and methods may include one or more sensors embedded and/or integrated in a composite wall of a vehicle such as a trailer, a gateway configured and coupled to the one or more sensors, and configured to wirelessly communicate information received from the one or more sensors to a server, further comprising software configured to receive, analyze, transmit and display information necessary for monitoring the integrity of the vehicle.

### TECHNICAL FIELD

The present disclosure generally relates to vessels such as tractor trailers, train cars and other vehicular components wherein such vessels comprise components and/or smart systems for real-time monitoring of various aspects of such vessels. Information is received from one or more sensors embedded in one or more structural components of the vessel (i.e., trailer).

### BACKGROUND

The use of composite panels, namely those having inner and outer skins and a continuous core material provided therebetween, are widely used in the formation of structural components of trailers (e.g., walls and floors) because they are strong and lightweight. Both of these properties are important in the formation of structural components of trailers as they must be strong enough to prevent, or substantially inhibit, damage to the contents being shipped or stored within the trailer. The structural components must also be lightweight because trailers, including their payload, are subjected to weight restrictions when traveling, such that the lighter the weight of the trailer is, the heavier the weight of the payload can be. Obviously, the larger the payload, the better.

As these structural components are made to be thinner and lighter, they are increasingly susceptible to damage (e.g., dents, punctures, overloading, torsion, and twisting). Companies that own and/or lease trailers may reduce their fleet maintenance cost by effectively monitoring trailers for damages, assessing the type and severity of damage, scheduling maintenance/repair activities in real time and charging back operators for damages. Current methods to identify and track damages are limited to visual inspections upon reaching a destination or completing a journey. Accordingly, what is needed are methods and components that enable the implementation of smart systems for real time monitoring of vessel damage. Preferably such systems and components further comprise features that enable internet connectivity as well as optional cloud storage and facilitate the flow of necessary information efficiently such that operators and/or owners are able to detect and monitor incidents and damages as they occur and gather other pertinent data for a variety of analytics.

### SUMMARY

The present disclosure provides components, systems and methods for real time monitoring and recording of events related to the performance and structural integrity of composite panels such as those used in structural components of vessels including trailers. In certain embodiments, such systems may be incorporated into insulating material and structural panels. The systems and methods may include one or more sensors embedded in a composite wall of a trailer, a gateway configured and coupled to the one or more sensors, and configured to wirelessly communicate information received from the one or more sensors to a server. In certain embodiments, software tools may be implemented within and/or alongside the sensor systems to enable the reception, transmission, analysis and display of relevant information. Ultimately, the components, sensors, methods and systems enable the gathering of relevant information quickly, and provide the operator with sufficient information to take corrective action as necessary.

### BRIEF DESCRIPTION OF THE DRAWINGS

The drawings described below are for illustration purposes only. The drawings are not intended to limit the scope of the present disclosure.

FIG. 1 is a top perspective view of a trailer;

FIG. 2 is a diagram illustrating an example of a first embedded sensor;

FIG. 3 is a diagram illustrating another example of a second embedded sensor;

FIG. 4 is a diagram illustrating forming a layer of glass fiber and resin on a first skin;

FIG. 5 is a diagram illustrating forming the first embedded sensor on the glass fiber and resin;

FIG. 6 is a diagram illustrating forming a thin cover layer and resin over the first embedded sensor;

FIG. 7 is a diagram illustrating forming a core member on the adhesive-coated thin cover layer;

FIG. 8 is a diagram illustrating forming a second skin on the core member;

FIG. 9 is a diagram illustrating an integrated sensor;

FIG. 10 is a system diagram illustrating a smart trailer application integrating the smart sensor array;

FIG. 11 is a diagram illustrating a damage alert generated on a computer device;

FIG. 12 is a diagram illustrating a damage alert generated on a driver's mobile device;

FIG. 13 is a diagram illustrating a flowchart for using the smart trailer application on a mobile device;

FIG. 14 is a diagram illustrating a global view of the smart trailer application;

FIG. 15 is a diagram illustrating a trailer status view with no issues of the smart trailer application;

FIG. 16 is a diagram illustrating the trailer status view with issues of the smart trailer application;

FIG. 17 is a diagram illustrating a wall damage view of the smart trailer application;

FIG. 18 is a diagram illustrating a wall damage image view of the smart trailer application;

FIG. 19 is a diagram illustrating a wall damage text view of the smart trailer application;

FIG. 20 is a diagram illustrating a floor overload view of the smart trailer application;

FIG. 21 is a trailer lights view of the smart trailer application; and

FIG. 22 a trailer lights diagnostics view of the smart trailer application.

### DETAILED DESCRIPTION

The present disclosure is related to systems and methods for real time monitoring and recording of events related to a vehicle, such as a trailer, including, but not limited to the performance and structural integrity of composite panels used in structural components of the vehicle, coordinates and speed of the vehicle, an amount of load within the trailer, a status of one or more lights on the vehicle, and a temperature inside and/or outside of the vehicle. The systems and methods may include one or more sensors embedded in a composite wall of a trailer, a gateway configured and coupled to the one or more sensors and configured to wirelessly communicate information received from the one or more sensors to a server, and further comprising software tools configured to receive, transmit, analyze and/or display the information.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description.

Examples of different smart trailer sensor systems will be described more fully hereinafter with reference to the accompanying drawings. These examples are not mutually exclusive, and features found in one example can be combined with features found in one or more other examples to achieve additional implementations. Accordingly, it will be understood that the examples shown in the accompanying drawings are provided for illustrative purposes only, and they are not intended to limit the disclosure in any way. Like numbers refer to like elements throughout.

In the following description, numerous specific details are set forth, such as particular structures, components, materials, dimensions, processing steps, and techniques, in order to provide a thorough understanding of the present embodiments. However, it will be appreciated by one of ordinary skill of the art that the embodiments may be practiced without these specific details. In other instances, well-known structures or processing steps have not been described in detail in order to avoid obscuring the embodiments.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. It will be understood that these terms are intended to encompass different orientations of the element in addition to any orientation depicted in the figures.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

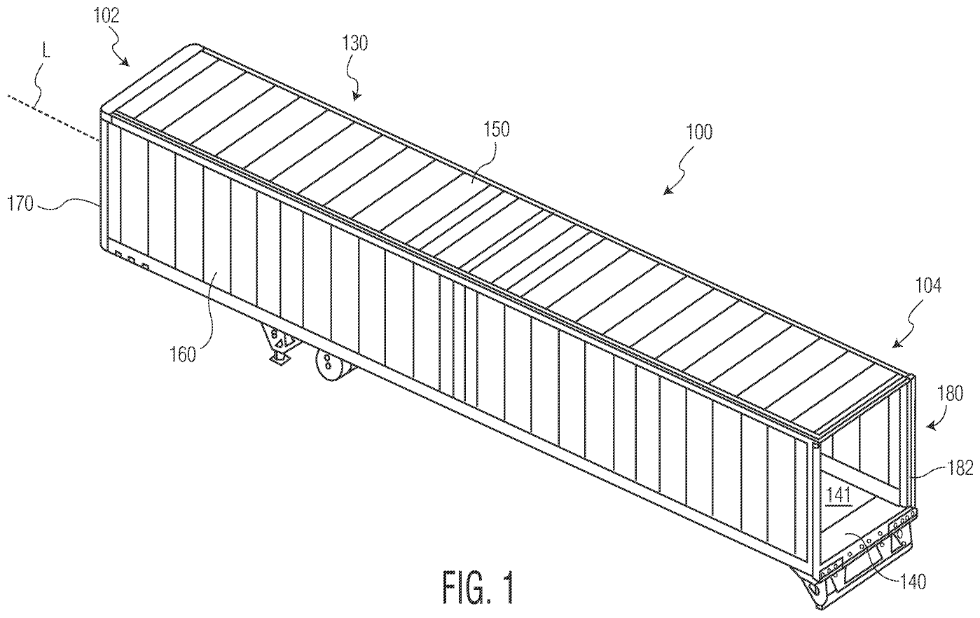

Referring now to FIG. 1, a top perspective view of a trailer 100 of the present disclosure is shown. The trailer may include a cargo body 130 with one or more structural components, such as a floor 140, a roof 150 , right and left sidewalls 160, a front wall or nose 170 at the front 102, and a rear door assembly 180 having a rear frame 182 and a door (not shown) to access the cargo body 130. As described in additional detail below, the structural components may include one or more embedded sensors and wires that allow an operator and/or owner to see damage to the cargo body 130 as it occurs and gather other pertinent data for analytics.

The floor 140 may include an upper surface 141 (i.e., platform) for supporting cargo and a lower surface (not shown) opposite the upper surface 141. Between the upper surface 141 and lower surface, the floor 140 may include a plurality of transverse beams (not shown) and, optionally, a plurality of insert beams (not shown) positioned between adjacent transverse beams, both of which extend in a direction transverse to a longitudinal axis L.

The cargo body 130 of trailer 100 may be an enclosed body. The cargo body 130 may be used for any type of conventional trailers (e.g., dry freight trailers, flatbed trailers, commercial trailers, small personal trailers) and/or box or van semi-trailers, and the like. In another example, the cargo body 130 may be refrigerated and/or insulated to transport temperature-sensitive cargo. Those skilled in the art will appreciate that the present invention may be implemented in a number of different applications and embodiments, such as train cars, cargo containers, shipping containers, and any other type of container or vehicle, and is not specifically limited in its application to the particular embodiments depicted herein.

The cargo body 130 may be constructed, at least in part, of composite materials. For example, the floor 140, roof 150, right and left sidewalls 160, and/or nose 170 of the cargo body 130 may be constructed of composite materials. As such, the cargo body 130, as well as the floor 140, roof 150, right and left sidewalls 160, and/or nose 170 of the cargo body 130, may be referred to herein as composite structures. These composite structures may lack internal metal components. Also, each composite structure may be a single, unitary component, which may be formed from a plurality of layers permanently coupled together. Other elements of the cargo body 130 may be constructed of non-composite (e.g., metallic) materials. For example, one or more of a rear frame 182 and a corner 140 of the cargo body 130 may be constructed of metallic materials.

Composite materials are generally formed by combining two or more different constituents that remain separate and distinct in the final composite material. Exemplary composite materials include fiber-reinforced plastics (FRP), for example carbon-fiber-reinforced plastics (CRP). Such materials may be formed from an extruded preform panel assembly of a woven or stitched fiberglass cloth, a non-woven spun bond polymeric material, and a foam core (not shown). These preform panels may be cut to size, combined in a mold resembling the final shape with other fiberglass and resin layers, and wetted with at least one resin and a catalyst to define a single structure during a curing process. The spun bond polymeric material may be mechanically stitched to the fiberglass cloth and/or the foam before the panels are wetted with resin. In one embodiment, the spun bond material may be a polyester material, the foam may be a polyurethane material, and the resin may be a thermoset plastic resin matrix.

The individual panels may be sized, shaped, and arranged in a manner that accommodates the strength requirements of the final structure. In areas of the final structure requiring less strength, the panels may be relatively large in size, with the foam cores spanning relatively large distances before reaching the surrounding fiberglass and polymeric skins. By contrast, in areas of the final structure requiring more strength, the panels may be relatively small in size, with the foam cores spanning relatively small distances before reaching the surrounding fiberglass and polymeric skins. For example, the panels may be shaped as relatively wide panels in areas of the final structure requiring less strength and as relatively narrow support beams in areas of the final structure requiring more strength. Other exemplary techniques for strengthening such support beams include reinforcing the outer skins, such as by using unidirectional glass fibers or additional cloth in the outer skins, and/or reinforcing the inner cores, such as by using hard plastic blocks or higher density foam in the inner cores.

In certain embodiments, after the curing process described above, a coating may be applied to the inner and/or outer surfaces of the cured panels. Additionally, metallic or non-metallic sheets or panels may be applied to the inner and/or outer surfaces of the cured panels, either in place of the coating or with the coating. The metallic sheets or panels may be comprised of stainless steel, aluminum, and/or coated carbon steel, and the non-metallic sheets or panels may be comprised of carbon fiber composites, for example. Other exemplary composite structures lack fiber-reinforced plastics and/or internal foam cores and, instead, may be comprised of polymeric cores (e.g., high-density polyethylene) with metal (e.g., high-strength steel) or polymeric outer skins coupled to the polymeric cores to provide a rigid but light-weight and durable composite materials.

Still other exemplary composite structures may be comprised of a cellular polymeric and/or metallic material. For example, in one embodiment, the polymeric material may be comprised of a plastically deformable material, such as a thin thermoplastic material, a fiber composite material, a plastically deformable paper, or a metal sheet, which defines a cellular honeycomb structure. The cellular honeycomb structure may include open cells and/or closed cells and each cell may have a circular or polygonal cross-sectional shape. Additionally, the cellular honeycomb structure may be joined with covering layers on one or both sides thereof for generally enclosing at least a portion of the honeycomb structure. For example, the covering layers may be directly extruded or laminated onto the honeycomb structure and may be comprised of metal and/or polymeric materials.

Various connections or joints of the composite cargo body 130 may be assembled, at least in part, using adhesive bonding. The adhesive may be a structural adhesive that is suitable for load-bearing applications. The adhesive may have a lap shear strength greater than 1 MPa, 10 MPa, or more, for ex-ample. Exemplary adhesives include, for example, epoxies, acrylics, urethanes (single and two part), polyurethanes, methyl methacrylates (MMA), cyanoacrylates, anaerobics, phenolics, and/or vinyl acetates. The adhesive may be selected based on the needs of the particular application.

The method used to form an adhesive bond may also vary according to the needs of the particular application. First, the surfaces receiving the adhesive (i.e., adherends) may be pre-treated, such as by abrading the surfaces, applying a primer, and/or cleaning the surfaces with a suitable cleaner (e.g., denatured alcohol). Second, the adhesive may be applied to the surfaces over a predetermined application time (i.e., “open” time) and at a predetermined application temperature. In certain embodiments, the application temperature may be below the glass-transition temperature of the adhesive. Third, pressure may be applied to the surfaces, such as by using clamps, weights, vacuum bags, and/or ratchet straps, for example. Finally, the adhesive may be allowed to solidify. Some adhesives may undergo a chemical reaction in order to solidify, referred to as curing. This curing may occur over a predetermined cure time and at a predetermined cure temperature. In certain embodiments, the adhesive may be heated during curing such that the cure temperature is higher than the application temperature.

Various connections of the composite cargo body 130 may be assembled using one or more connectors, which may include brackets, braces, plates, and combinations thereof, for example. The connectors may vary in size and shape. For example, suitable connectors may be L-shaped, C-shaped, T-shaped, pi-shaped, flat, or bent. The connectors may be constructed of metallic materials (e.g., aluminum, titanium, or steel), polymeric materials, wood, or composite materials. In certain embodiments, the connectors are constructed of materials which are dissimilar from the composite material used to construct the composite cargo body 130. The connectors may be fabricated by extrusion, pultrusion, sheet forming and welding, roll forming, and/or casting, for example.

The connectors may be adhesively bonded to composite structures of the cargo body 130. For example, the connectors may be adhesively bonded to the composite floor 140, the composite roof 150, the composite right and left sidewalls 160, and/or the composite nose 170 of the cargo body 130. The connectors may be mechanically fastened to non-composite (e.g., metallic) structures of the cargo body 130. For example, the connectors may be mechanically fastened to the metallic rear frame 182 of the cargo body 130. Suitable mechanical fasteners include bolts, rivets, and screws, for example. Each connector may be a single-piece or a multi-piece construct. For multi-piece constructs, the pieces may be welded, mechanically fastened, adhered, snap-fit, or otherwise coupled together.

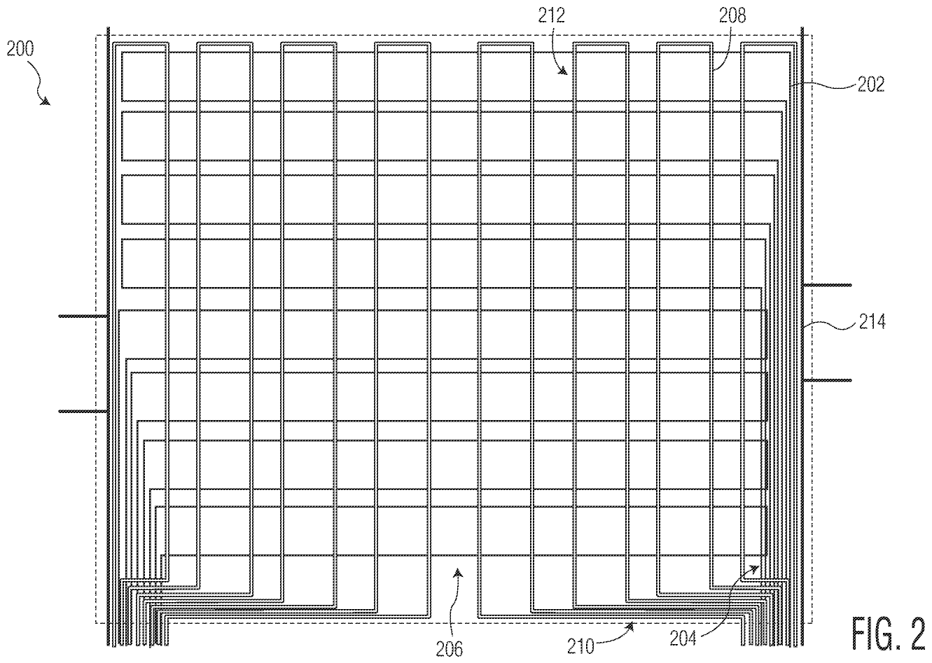

Referring now to FIG. 2, a diagram illustrating an example of a first embedded sensor 200 is shown. The first embedded sensor 200 may be incorporated into one or more of the structural components of the cargo body 130. For example, the first embedded sensor 200 may be incorporated into one or more of the sidewalls 160 of the cargo body. The first embedded sensor 200 may be formed as a section. The section may be substantially rectangular in shape. Although FIG. 2 shows the section may have a height and width corresponding to a single panel of the sidewall 160, embodiments are contemplated in which the section may have a height and width corresponding to the entire sidewall 160. The first embedded sensor 200 may be a puncture sensor.

As shown in FIG. 2, first embedded sensor 200 may include a plurality of first wires 202. Each of the first wires 202 may be a loop having endpoints located in proximity of a corner of the section, a first portion 204 extending along a first edge of the section, and a second portion 206 extending perpendicular from the first edge across section. The second portion 206 of each of the first wires 202 are separated by a first predetermined distance. The first embedded sensor 200 may further include a plurality of second wires 208. Each of the second wires 208 may be a loop having endpoints located in proximity of the corner of the section, a first portion 210 extending along a second edge of the section (the second edge being perpendicular to the first edge), and a second portion 212 extending perpendicular from the second edge across the section. The second portion 212 of each of the second wires 208 may be separated by a second predetermined distance. The first wires 202 and the second wires 208 may be woven into one or more layers of mesh.

The first embedded sensor 200 may also include one or more continuity sensors coupled to the endpoints of the first wires 202 and the endpoints of the second wires 208. The one or more continuity sensors may be configured to determine a break at a specific point in one or more of the first wires 202 and the wires, thereby indicating a location of a puncture of the section.

The first wires 202 may correspond to rows and the second wires 208 may correspond to columns. The one or more continuity sensors may be determine a location of the puncture based on a lack of continuity in one or more of the rows and the columns. The first wires 202 and the second wires 208 may each be coated wire having a thickness of approximately 10 gauge to 40 gauge. The first predetermined distance and the second predetermined distance may be any distance. In one example, the first predetermined distance and the second predetermined distance may be equal.

In an example, the one or more layers of mesh may include a single layer of one or more of a resin, a plastic, and a composite material. In another example, the one or more layers of mesh may include two layers of one or more of a resin, a plastic, and a composite material.

The first embedded sensor 200 may also include a plurality of third wires 214 for power distribution. The third wires 214 may be located along one or more of the first edge and a third edge of the section. The third edge may be located opposite of the first edge. In an example, the third wires 214 may also be woven into the one or more layers of mesh. The third wires 214 may have a larger gauge than the first wires and the second plurality of wires. For example, the third wires 214 may include coated wire having a thickness of approximately 10 gauge to 40 gauge. The third wires 214 may provide power for the first embedded sensor 200 and one or more additional sensors as described below. The third wires 214 may be adapted to provide power to the first embedded sensor 200, the one or more one or more continuity sensors, and one or more additional sensors or devices present in and/or on the panels, and/or assemblies that include the panels.

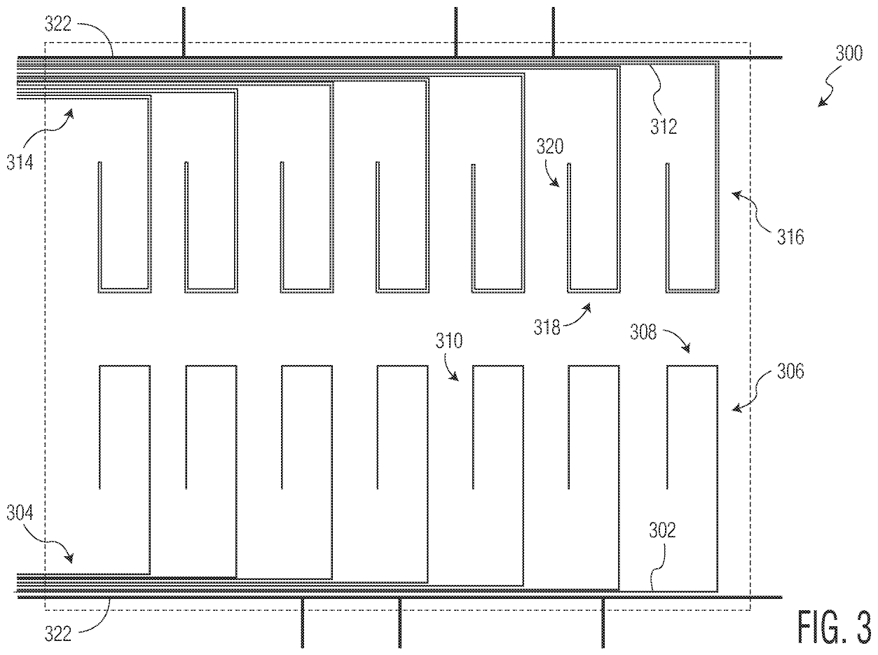

Referring now to FIG. 3, a second embedded sensor 300 is shown. As shown in FIG. 3, the second embedded sensor 300 may include a plurality of first wires 302. Each of the first wires 302 may have a first endpoint located in a first corner of the section, a first portion 304 that runs along a first edge of the section, a second portion 306 that extends perpendicular away from the first edge, a third portion 308 that runs parallel to the first edge, a fourth portion 310 that extends perpendicular to the first edge, and a second endpoint located below the first edge. The second portion 306 and the fourth portion 310 may be separated by a first predetermined distance. The second embedded sensor 300 may be a puncture sensor.

The second embedded sensor 300 may also a plurality of second wires 312. Each of the second wires 312 may have a first endpoint located in a second corner of the section, a first portion 314 that runs along a second edge of the section (opposite the first edge of the section), a second portion 316 that extends perpendicular away from the second edge, a third portion 318 that runs parallel to the second edge, a fourth portion 320 that extends perpendicular to the second edge, and a second endpoint located below the second edge. The second portion 316 and the fourth portion 320 may be separated by a second predetermined distance. The first wires 302 and the second wires 312 may be woven into one or more layers of mesh.

The second embedded sensor 300 may also include one or more sensors coupled to the endpoints of the first wires 302 and the endpoints of the second wires 312 that measure resistance. The one or more sensors may be configured to determine a break at a specific point in one or more of the first wires 302 and the second wires 312, thereby indicating a location of a puncture of the section.

The first wires 302 and the second wires 312 may each be coated wire having a thickness of approximately 10 gauge to 40 gauge. The first predetermined distance and the second predetermined distance may be any distance. In one example, the first predetermined distance and the second predetermined distance may be equal.

In an example, the one or more layers of mesh may include a single layer of one or more of a resin, a plastic, and a composite material. In another example, the one or more layers of mesh may include two layers of one or more of a resin, a plastic, and a composite material.

The second embedded sensor 300 may also include a plurality of third wires 322 for power distribution. The third wires 322 may be located along one or more of the first edge and the second edge of the section. In an example, the third wires 322 may also be woven into the one or more layers of mesh. The third wires 322 may have a larger gauge than the first wires 302 and the second wires 312. For example, the third wires 322 may include coated wire having a thickness of approximately 10 gauge to 40 gauge. The third wires 322 may provide power for the second embedded sensor 300 and one or more additional sensors as described below.

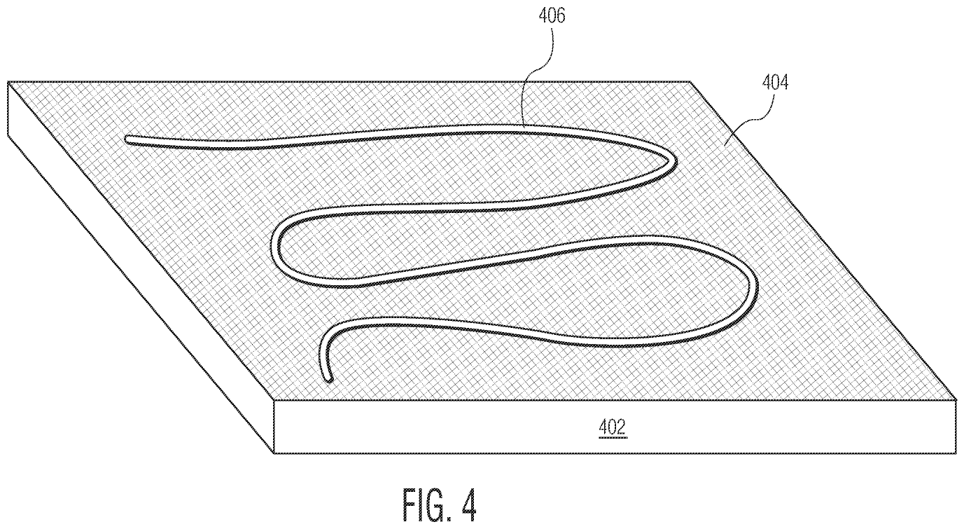

Referring now to FIGS. 4-8, diagrams illustrating a process of integrating the first embedded sensor 200 into one or more sidewalls 160 of the cargo body 130 are shown. It should be noted that, although the first embedded sensor 200 is shown, a similar process may be used to incorporate the second embedded sensor 300 into the one or more sidewalls 160. As described above, the one or more sidewalls 160 may be a composite material. The composite material have a core made of, for example, polyurethane foam. The core may be covered with glass fiber and a resin.

The first embedded sensor 200 shown in FIGS. 4-8 may have a section with a height and width that corresponds to an individual panel of the sidewall 160. It should be noted that the first embedded sensor 200 may have a height and width that corresponds to the entire sidewall 160. The section and the panel may have a width of approximately 24-30 inches, a height corresponding to a height of the cargo body 130, and a thickness of approximately 2-3 inches. The individual panel may be joined to other panels in a mold with additional glass fiber and resin to make a continuous sidewall 160. The sidewall 160 may have a width of approximately 53 feet. A final gel coat may be added to each individual panel (or the entire sidewall 160) for protection and aesthetics.

FIG. 4 illustrates forming a layer of glass fiber 404 and resin 406 on a first skin 402. The first skin 402 may be may be a thin composite material and can range in thickness (such as 0.026 inches). It is to be understood that other thicknesses may be used as required by the application.

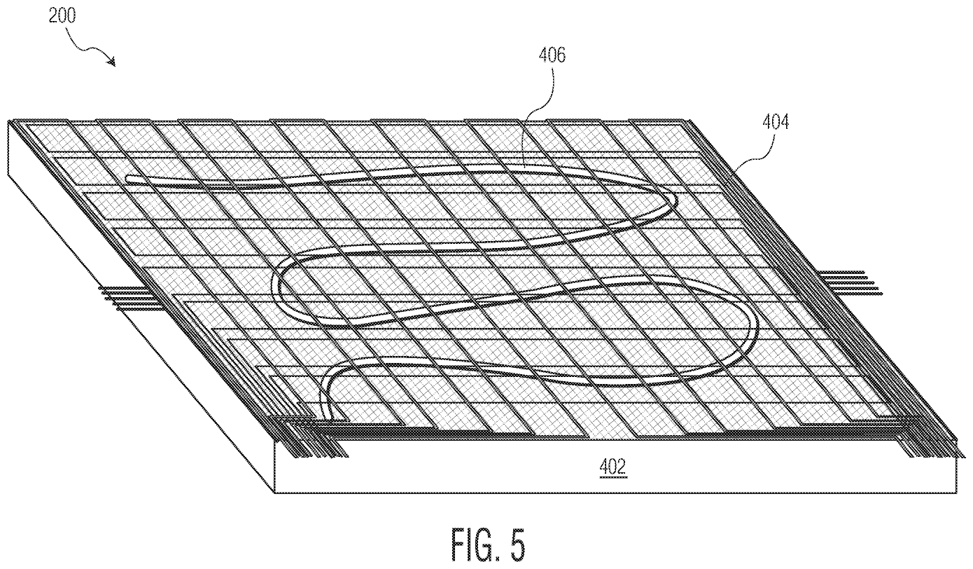

FIG. 5 illustrates forming the first embedded sensor 200 on the glass fiber 404 and resin 406. As described above, the first embedded sensor 200 may include a plurality of first wires 202 and a plurality of second wires 208. The plurality of first wires 202 and a plurality of second wires 208 may be woven into the glass fiber 404 or may be positioned directly on the glass fiber 404 and resin 406.

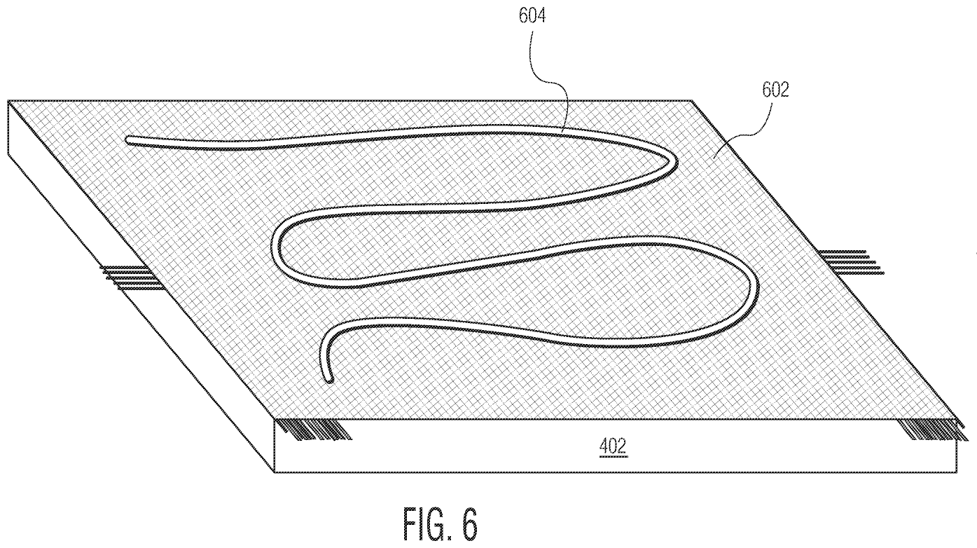

FIG. 6 illustrates forming a thin cover layer 602 over the first embedded sensor 200. The thin cover layer may be coated with an adhesive 604.

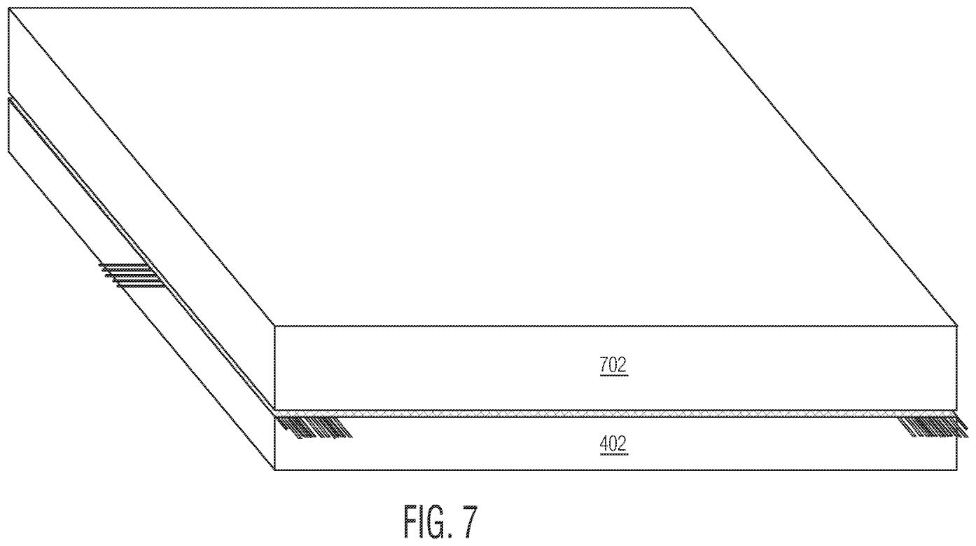

FIG. 7 illustrates forming a core member 702 on the adhesive-coated thin cover layer 602. The core member 702 may be made of some type of compressible non-metal material, preferably thermoplastic, such as polyurethane, polypropylene, or high density polyethylene.

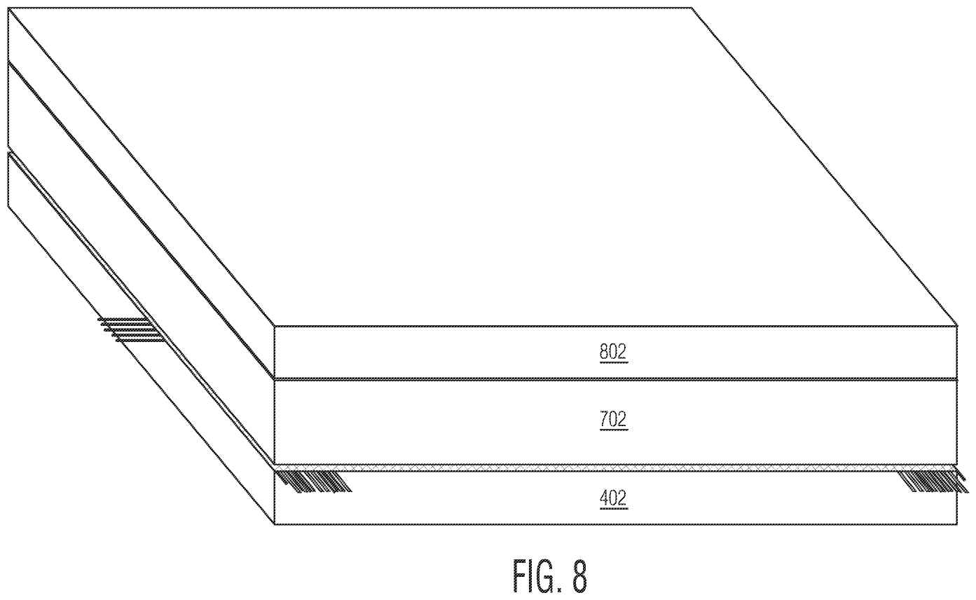

FIG. 8 illustrates forming a second skin 802 on the core member 702. As described above, the second skin 802 may be formed on the core member 702 using an adhesive.

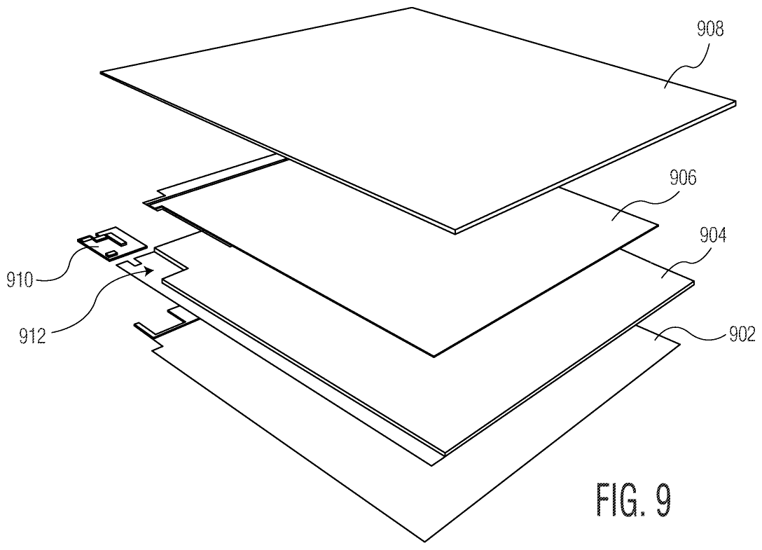

Referring now to FIG. 9, a diagram illustrating an integrated sensor 900 is shown. The integrated sensor 900 may comprise a smart panel that may be incorporated into one or more of the structural components of the cargo body 130. For example, the integrated sensor 900 may be incorporated into one or more of the sidewalls 160 of the cargo body. The integrated sensor 900 may be substantially rectangular in shape (or any other shape suitable for the function). A plurality of integrated sensor 900 may be joined together to form the sidewall 160.

The integrated sensor 900 may be a capacitive grid tile that can detect physical changes such as pressure changes (e.g., impacts, dents, punctures, etc.). The integrated sensor 900 may include a first thermoplastic polymer resin (TPR) layer 902 that includes a first conductive material. A non-conductive compressive layer 904 may be formed on the first TPR layer 902. A second TPR layer 906 may be formed on the non-conductive compressive layer 904. The second TPR layer 906 may include a second conductive material. The integrated sensor 900 may include a printed circuit board (PCB) 910 that is contained in a notch 912 formed in the non-conductive compressive layer 904. The PCB 910 may be coupled to the first TRP layer 902 and the second TPR layer 906 and configured to measure at least a capacitance across the non-conductive compressive layer. The smart panel may also include a protective layer 908 on the second TPR layer 906.

The first TPR layer 902 and the second TPR layer 906 may comprise polyethylene terephthalate (PET). The non-conductive compressive layer 904 may comprise a foam insulator. The PCB 910 may be coupled to the first TRP layer 902 and the second TPR layer 906 via one or more zero insertion force (ZIF) connectors. The PCB 910 may be further configured to measure one or more data points such as acceleration and/or temperature. The PCB 910 may be further configured to communicate data to a processing gateway via one or more cables. The PCB 910 may be further configured to communicate with one or more adjacent PCBs in one or more adjacent smart panels in the sidewall 160 via one or more cables. The PCB 910 may be located in a corner of the non-conductive compressive layer 904 such that a connector of the PCB 910 is exposed for connection to one or more adjacent PCBs or wiring.

Two or more integrated sensors 900 may be connected to form an array. The array of integrated sensors 900 may be arranged to form a continuous surface (e.g., sidewall 160). Each integrated sensor 900 may be electrically connected to at least one adjacent panel via one or more cables. As described above, the PCB of each smart panel may be exposed to enable connection to one or more adjacent smart panels.

One or more of the first embedded sensor 200, the second embedded sensor 300, and the integrated sensor 900 may be combined with additional sensors in the cargo body 130 to form a smart sensor array. The additional sensors may include one or more of a load sensor in the floor 140, a fatigue sensor in the floor 140, a thermocouple inside and/or outside the cargo body 130, a barometer, a humidity an accelerometer, and a global positioning system (GPS) unit. Each sensor in the smart sensor array may be coupled to a gateway. The gateway may provide power to the sensors and may provide short-duration battery backup when the cargo body 130 is not powered.

The gateway may include a processor, a transceiver, a transmit/receive element, non-removable memory, removable memory, a power source, a GPS chipset, and/or other peripherals, among others. It will be appreciated that the gateway may include any sub-combination of the foregoing elements while remaining consistent with an embodiment.

The processor may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor may perform signal coding, data processing, power control, input/output processing, and/or any other functionality that enables the gateway to operate in a wireless environment. The processor may be coupled to the transceiver, which may be coupled to the transmit/receive element. The processor and the transceiver may be separate components, or may be integrated together in an electronic package or chip.

The transmit/receive element may be configured to transmit signals to, or receive signals from, a base station over an air interface. For example, in one embodiment, the transmit/receive element may be an antenna configured to transmit and/or receive radiofrequency (RF) signals. In an embodiment, the transmit/receive element may be an emitter/detector configured to transmit and/or receive infrared (IR), ultraviolet (UV), or visible light signals, for example. In yet another embodiment, the transmit/receive element may be configured to transmit and/or receive both RF and light signals. It will be appreciated that the transmit/receive element may be configured to transmit and/or receive any combination of wireless signals.

The transmit/receive element may be a single element or may include any number of individual transmit/receive elements. More specifically, the gateway may employ MIMO technology. Thus, in one embodiment, the gateway may include two or more transmit/receive elements (e.g., multiple antennas) for transmitting and receiving wireless signals over the air interface.

The transceiver may be configured to modulate the signals that are to be transmitted by the transmit/receive element and to demodulate the signals that are received by the transmit/receive element. As noted above, the gateway may have multi-mode capabilities. Thus, the transceiver may include multiple transceivers for enabling the gateway to communicate via multiple RATs, such as new radio (NR) and IEEE 802.11, for example.

The processor of the gateway may be coupled to, and may receive input data from, the smart sensor array. In addition, the processor may access information from, and store data in, any type of suitable memory, such as the non-removable memory and/or the removable memory. The non-removable memory may include random-access memory (RAM), read-only memory (ROM), a hard disk, or any other type of memory storage device. The removable memory may include a subscriber identity module (SIM) card, a memory stick, a secure digital (SD) memory card, and the like. In other embodiments, the processor may access information from, and store data in, memory that is not physically located on the gateway, such as on a server or a home computer (not shown).

The processor may receive power from the power source, and may be configured to distribute and/or control the power to the other components in the gateway. The power source may be any suitable device for powering the gateway. For example, the power source may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor may also be coupled to the GPS chipset, which may be configured to provide location information (e.g., longitude and latitude) regarding the current location of the gateway. In addition to, or in lieu of, the information from the GPS chipset, the gateway may receive location information over the air interface from a base station and/or determine its location based on the timing of the signals being received from two or more nearby base stations. It will be appreciated that the gateway may acquire location information by way of any suitable location-determination method while remaining consistent with an embodiment.

The processor may further be coupled to other peripherals, which may include one or more software and/or hardware modules that provide additional features, functionality and/or wired or wireless connectivity. For example, the peripherals may include a Bluetooth® module, a frequency modulated (FM) radio unit.

The gateway may include a full duplex radio for which transmission and reception of some or all of the signals (e.g., associated with particular subframes for both the uplink (UL) (e.g., for transmission) and downlink (DL) (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via the processor). In an embodiment, the gateway may include a half-duplex radio for which transmission and reception of some or all of the signals (e.g., associated with particular subframes for either the UL (e.g., for transmission) or the DL (e.g., for reception)).

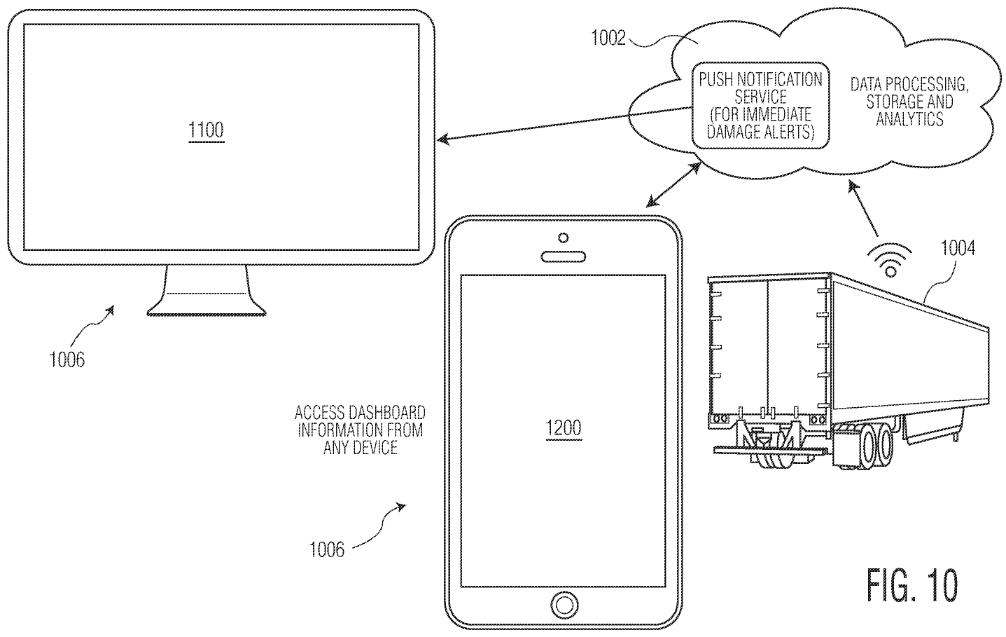

Referring now to FIG. 10, a system diagram illustrating a smart trailer application integrating the smart sensor array is shown. The gateway may transmit information from the smart sensor array to one or more servers 1002 over a wireless interface 1004. The one or more servers 1002 may process the information and transmit the processed information to one or more user devices. The one or more user devices 1006 may include a process operatively coupled to a graphical user interface (GUI). Once the processed information is received by the one or more user devices, the processor may cause the GUI to generate one or more displays. The one or more user devices may include a computer device, such as a personal computer, or a mobile device.

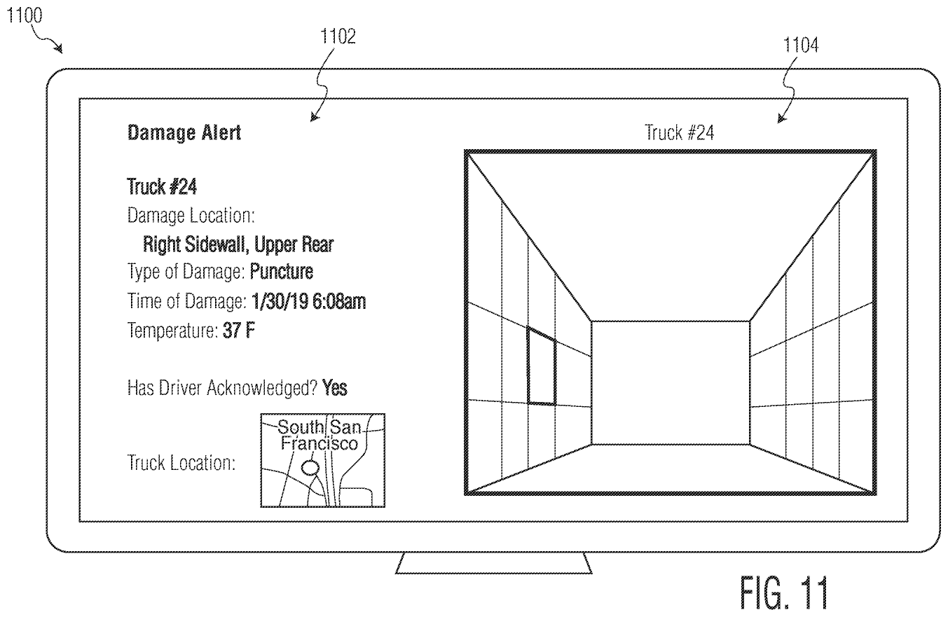

Referring now to FIG. 11, a diagram illustrating a damage alert 1100 generated on a computer device is shown. The damage alert 1100 may include a first area 1102 that displays textual information, such as a trailer identification, a damage location, a type of damage, a time the damage occurred, and a temperature. The first area 1102 may also include a graphical representation of a location of the trailer. The first area 1102 may also display an indication of whether or not the driver of the trailer has acknowledged the damage. The damage alert 1100 may also include a second area 1104 that shows a three-dimensional representation of the interior of a trailer and what area within the trailer damage (e.g., which sensor) has been recorded.

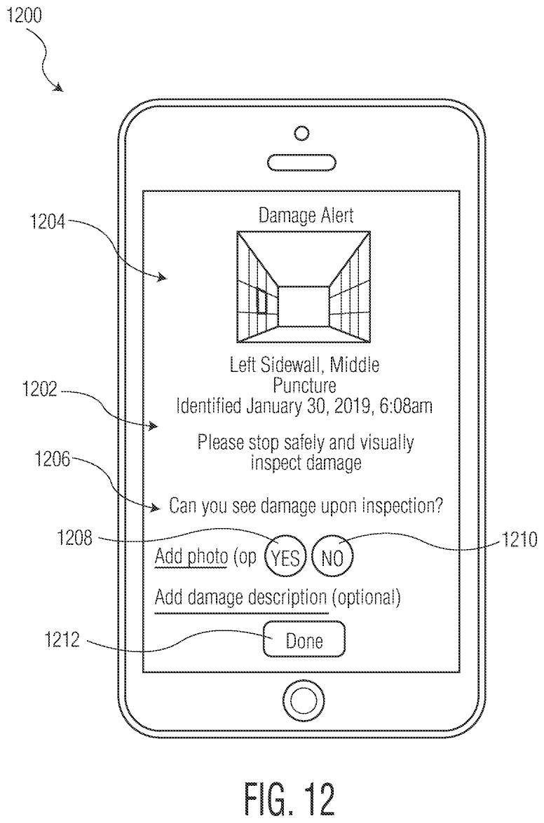

Referring now to FIG. 12, a diagram illustrating a damage alert 1200 generated on a driver's mobile device is shown. The driver may receive one or more of a text message to his mobile device as well as the damage alert 1200. The driver can either open an application or click on a link contained in the text message for damage details. The damage alert 1200 may include a first area 1202 that displays textual information, such as a damage location, a time the damage occurred. The damage alert 1200 may also include a second area 1204 that shows a three-dimensional representation of the interior of a trailer and what area within the trailer damage (e.g., which sensor) has been recorded. The damage alert 1200 may also include a third area 1206 that includes a prompt for the driver to stop and visually inspect the damage. The third area 1206 may include a clickable “yes” button 1208 and a clickable “no” button 1210 that allow the driver to indicate if the damage is visible upon inspection. The third area 1206 may include a link that allows the driver to optionally upload a photo of the damage and a link that allows the driver to provide a description of the damage. The damage alert 1200 may include a “done” button 1212 for the driver to submit a damage report.

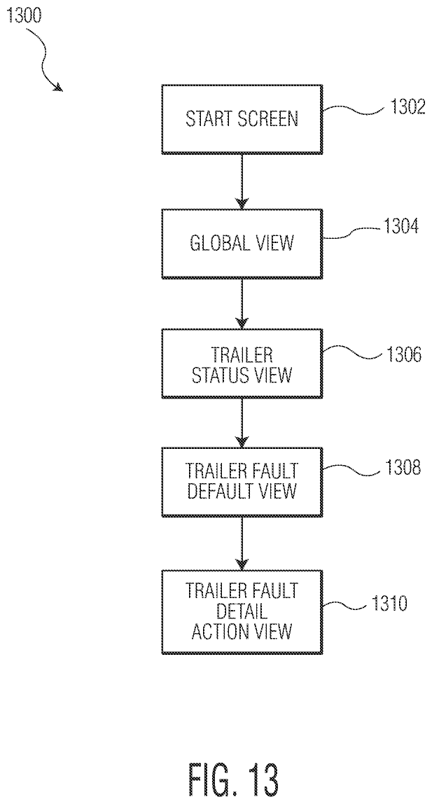

Referring now to FIG. 13, a diagram illustrating a flowchart 1300 for using the smart trailer application on a mobile device is shown. The smart trailer application may include one or more GUIs, including a start screen 1302, a global view 1304, a trailer status view 1306, a trailer fault detail view 1308, and a trailer fault detail action view 1310 that users can navigate between. A user may open the smart trailer application and may be presented with the start screen 1302 showing one or more initial graphics.

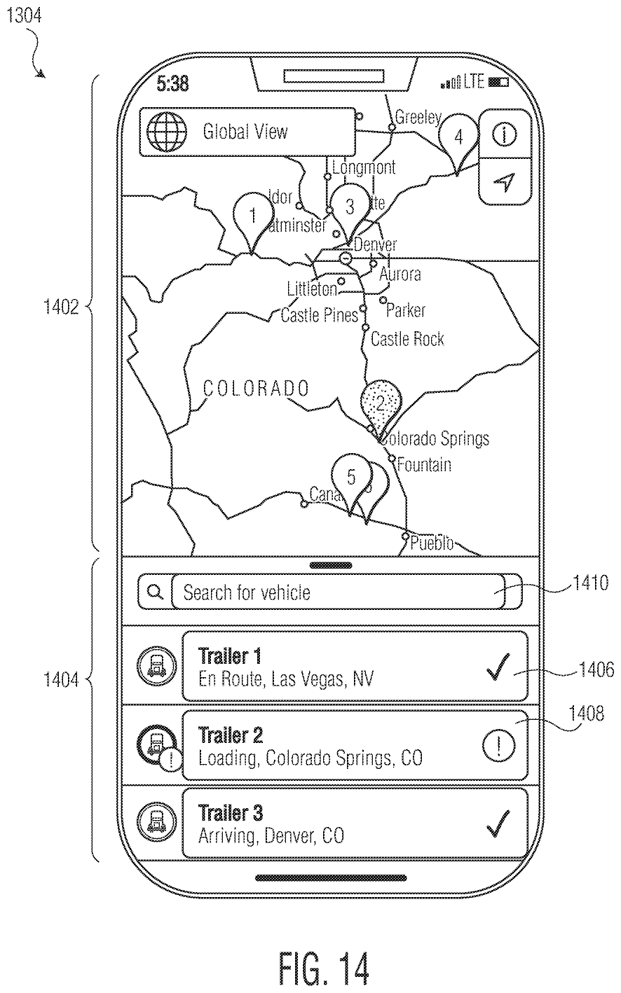

Referring now to FIG. 14, a diagram illustrating the global view 1304 of the smart trailer application is shown. The global view 1304 may include a first area 1402 and a second area 1404. The first area 1402 may include a map displaying one or more trailers as pinpoints to indicate their location. The second area 1404 may include overall status information for the one or more trailers shown on the map. In an example, all trailers shown on the map may be displayed in the second area 1404. In other words, although trailers 1, 2, and 3 are shown, scrolling down may show additional trailers 4, 5 and 6. The second area 1404 may include a search field 1410 that allows users to search for a specific vehicle.

The second area 1404 may include a clickable callout for each trailer that may display a present state (e.g., current location, destination, moving, loading, idle, departing, and arriving) along with an indication of whether the trailer has no issues (e.g., green check) or if there is one or more issues detected (e.g., red exclamation point). For example, a first callout 1406 for trailer 1 shows that it is en route to Las Vegas, Nev. and has no issues. A second callout 1408 for trailer 2 shows that it is loading in Colorado Springs, Colo. and has one or more issues. Selecting a callout may open the trailer status view 1306 for the selected trailer.

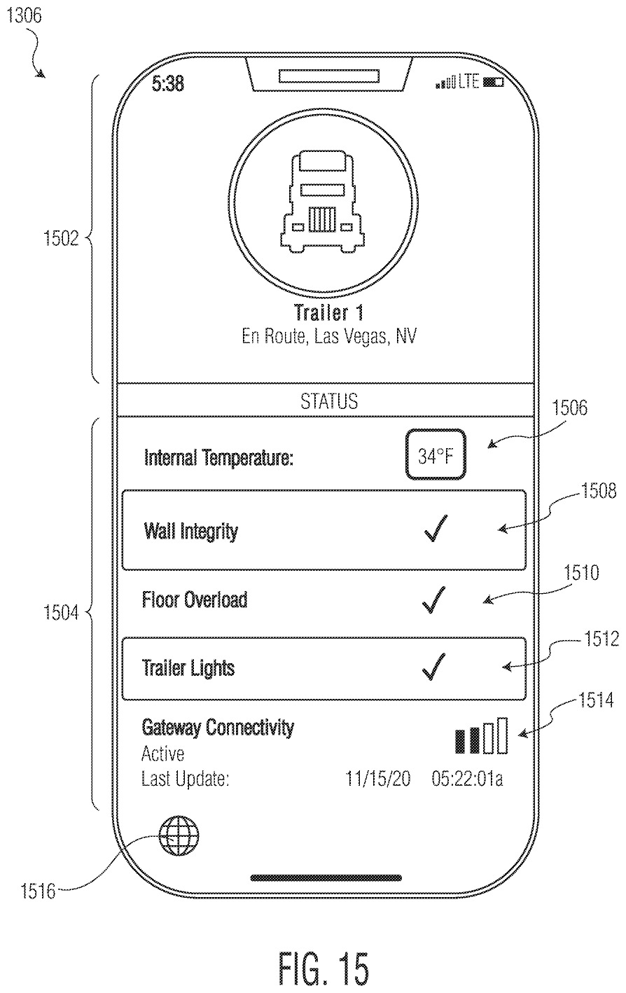

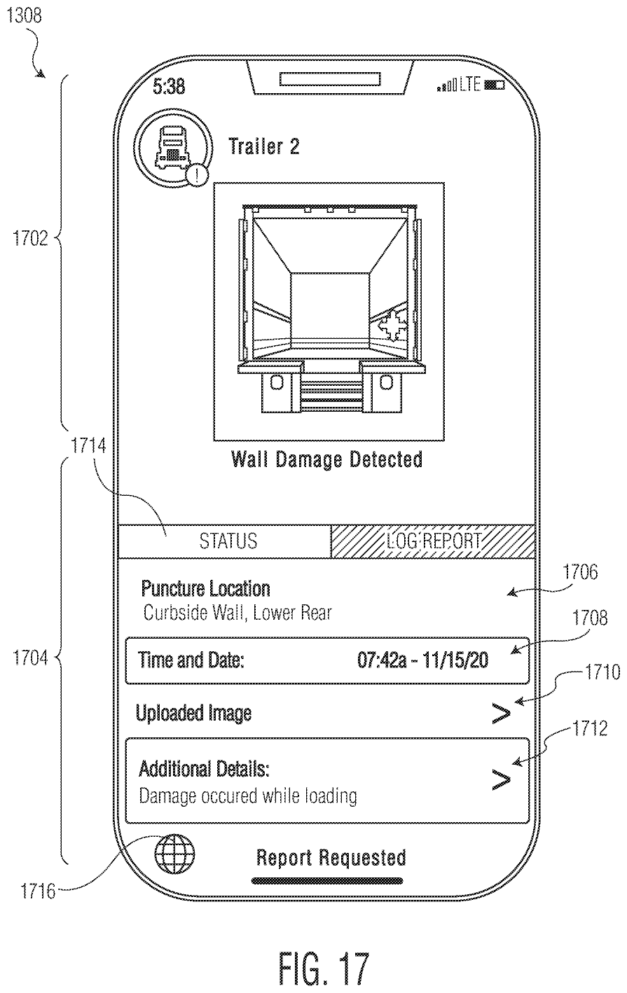

Referring now to FIG. 15, a diagram illustrating the trailer status view 1306 for trailer 1 is shown. The trailer status view 1306 for trailer 1 may be presented to a user after selecting the first callout 1406 on the global view 1304. FIG. 17 illustrates a trailer status view 1306 for a trailer with no issues. The trailer status view 1306 may include a first area 1502 and a second area 1504. The first area 1502 may include identifying information about the selected trailer. For example, the first area 1502 shows that trailer 1 is en route to Las Vegas, Nev. The second area 1504 may include one or more status indicators for different aspects of the trailer. For example, the second area 1504 may include an internal temperature indicator 1506, a wall integrity indicator 1508, a floor overload indicator 1510, a trailer lights indicator 1512, and a gateway connectivity indicator 1514. When a status indicator is positive (e.g., a green checkmark) and there are no issues detected, the status indicator may not be selectable. No “Log Report” may be available when all status are in range. The trailer status view 1306 may include a globe icon 1516, which can be selected to return to the global view 1304 at any time.

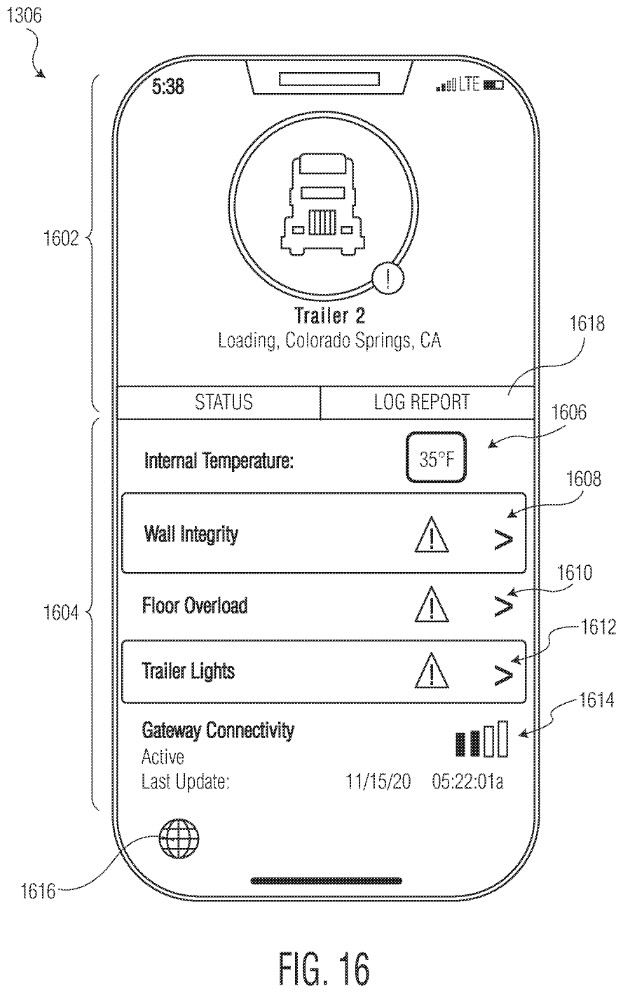

Referring now to FIG. 16, a diagram illustrating the trailer status view 1306 for trailer 2 is shown. The trailer status view 1306 for trailer 2 may be presented to a user after selecting the second callout 1408 on the global view 1304. FIG. 17 illustrates a trailer status view 1306 for a trailer with one or more issues. The trailer status view 1306 may include a first area 1602 and a second area 1604. The first area 1602 may include identifying information about the selected trailer. For example, the first area 1602 shows that trailer 1 is loading in Colorado Springs, Colo. The second area 1604 may include one or more status indicators for different aspects of the trailer. For example, the second area 1604 may include an internal temperature indicator 1606, a wall integrity indicator 1608, a floor overload indicator 1610, a trailer lights indicator 1612, and a gateway connectivity indicator 1614. When a status indicator indicates an issue (e.g., an exclamation point), the status indicator may be selectable and may open the trailer fault default view 1308 for the selected issue. A “Log Report” 1618 may be available when an issue is detected. The trailer status view 1306 may include a globe icon 1616, which can be selected to return to the global view 1304 at any time.

Referring now to FIG. 17, a diagram illustrating the trailer fault default view 1308 for the wall integrity indicator 1608 is shown. The trailer fault default view 1308 for wall damage may include a first area 1702 and a second area 1704. The first area 1702 may include a graphical representation of the interior of a trailer indicating where damage was detected. The second area 1704 may include information about the damage. For example, the second area 1704 may include a damage location indicator 1706, a time and date indicator 1708, an image upload prompt 1710, and an additional details prompt 1712. Selecting either the image upload prompt 1710 or the additional details prompt 1712 will open the trailer fault detail action view 1310. The user can return to the trailer status view 1306 by selecting the status button 1714. The trailer fault default view 1308 may include a globe icon 1716, which can be selected to return to the global view 1304 at any time.

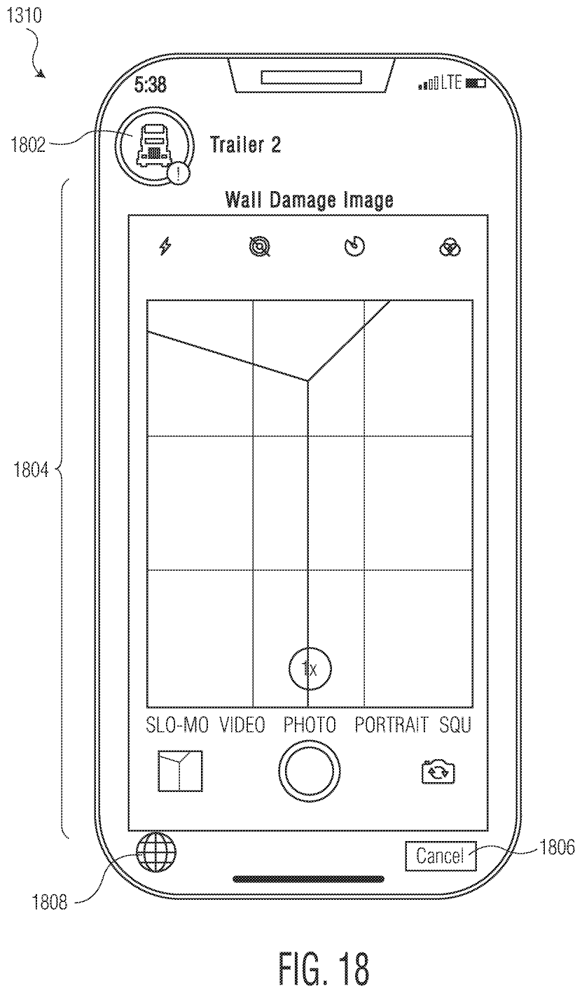

Referring now to FIG. 18, a diagram illustrating the trailer fault detail action view 1310 for the image upload prompt 1710 is shown. The trailer fault detail action view 1310 may include an identity of the trailer 1802, and a camera area 1804 that allows a user to photograph any damage. Once taken, the photograph may be uploaded and the user will be returned to the trailer fault default view 1308. The user may return to the trailer fault default view 1308 without taking a photograph by selecting a “Cancel” button 1806 on the bottom right of screen. The trailer fault detail action view 1310 may include a globe icon 1808, which can be selected to return to the global view 1304 at any time.

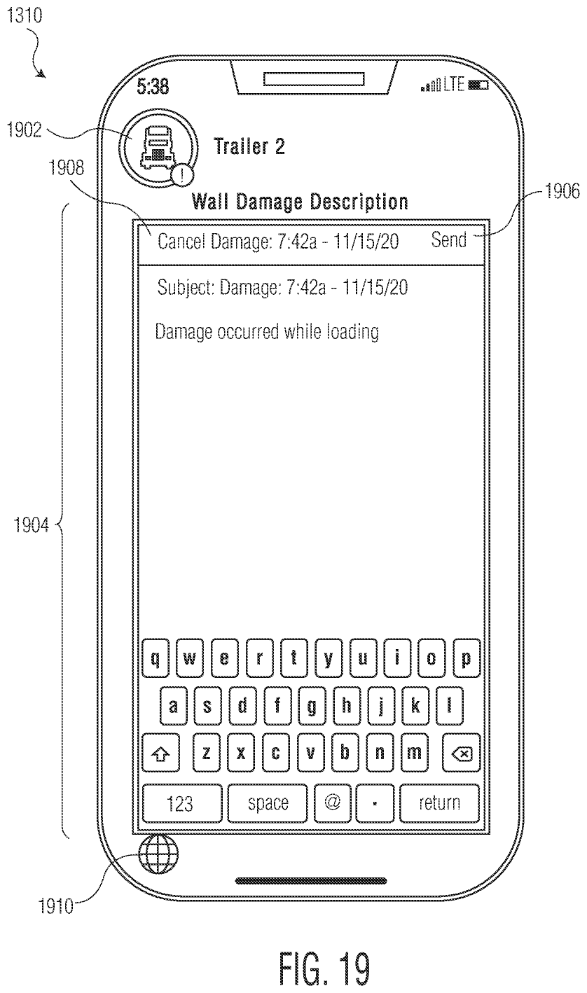

Referring now to FIG. 19, a diagram illustrating the trailer fault detail action view 1310 for the additional details prompt 1712 is shown. The trailer fault detail action view 1310 may include an identity of the trailer 1902, and a text area 1904 that allows a user to enter a description of any damage. Once the user enters the description and clicks a “Send” button 1906, the report may be uploaded and the user may be returned to the trailer fault default view 1308. The user can return to the trailer fault default view 1308 by selecting a “Cancel” button 1908 on the top left of text area 1904. The trailer fault detail action view 1310 may include a globe icon 1910, which can be selected to return to the global view 1304 at any time.

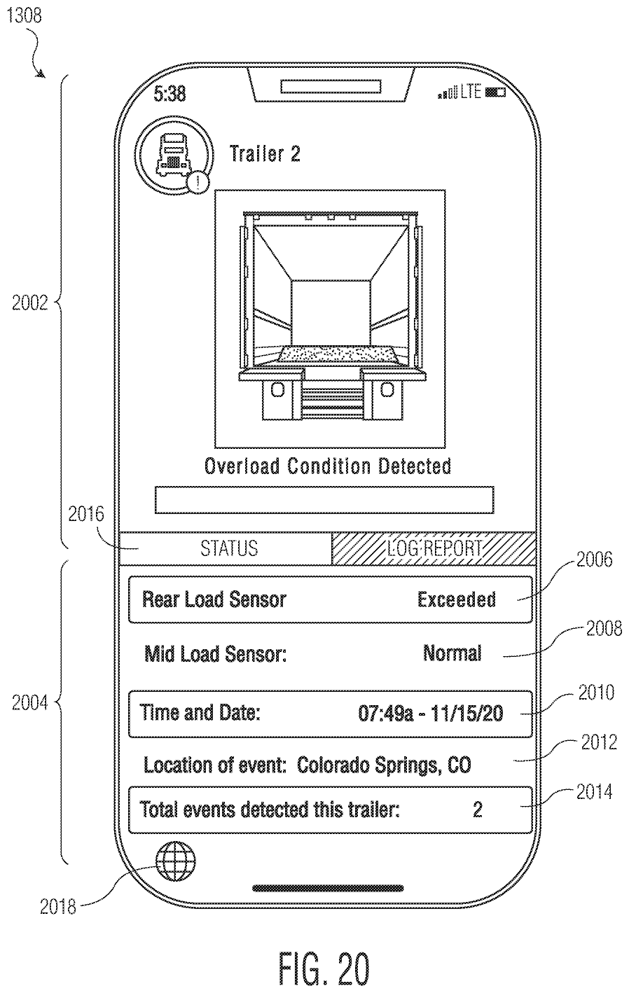

Referring now to FIG. 20, a diagram illustrating the trailer fault default view 1308 for the floor overload indicator 1610 is shown. The trailer fault default view 1308 for floor overload may include a first area 2002 and a second area 2004. The first area 2002 may include a graphical representation of the interior of a trailer indicating where an overload was detected. The second area 2004 may include information about one or more load sensors in the floor of the trailer. For example, the second area 2004 may include a rear load sensor indicator 2006, a middle load sensor indicator 2008, a time and date indicator 2010, a location indicator 2012, and a total events indicator 2014. The user can return to the trailer status view 1306 by selecting a status button 2016. The trailer fault default view 1308 may include a globe icon 2018, which can be selected to return to the global view 1304 at any time.

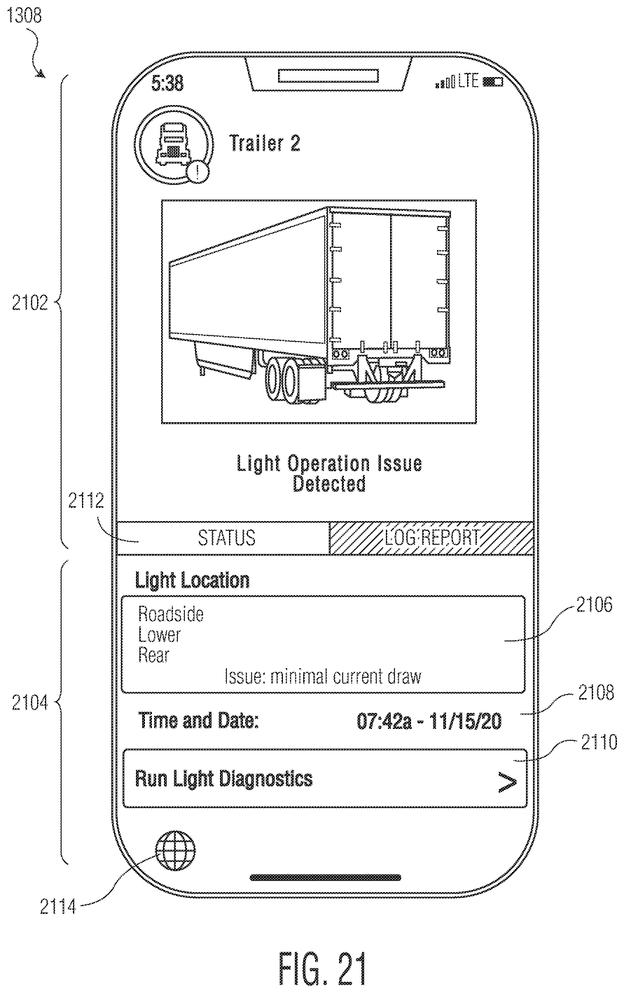

Referring now to FIG. 21, a diagram illustrating the trailer fault default view 1308 for the trailer lights indicator 1612 is shown. The trailer fault default view 1308 for trailer lights may include a first area 2102 and a second area 2104. The first area 2102 may include a graphical representation of the exterior of a trailer indicating where issues with the trailer lights are detected. The second area 2004 may include information about the trailer lights. For example, the second area 2104 may include a light location and issue indicator 2106, a time and date indicator 2108, and a light diagnostics prompt 2110. The user can return to the trailer status view 1306 by selecting a status button 2112. The trailer fault default view 1308 may include a globe icon 2114, which can be selected to return to the global view 1304 at any time.

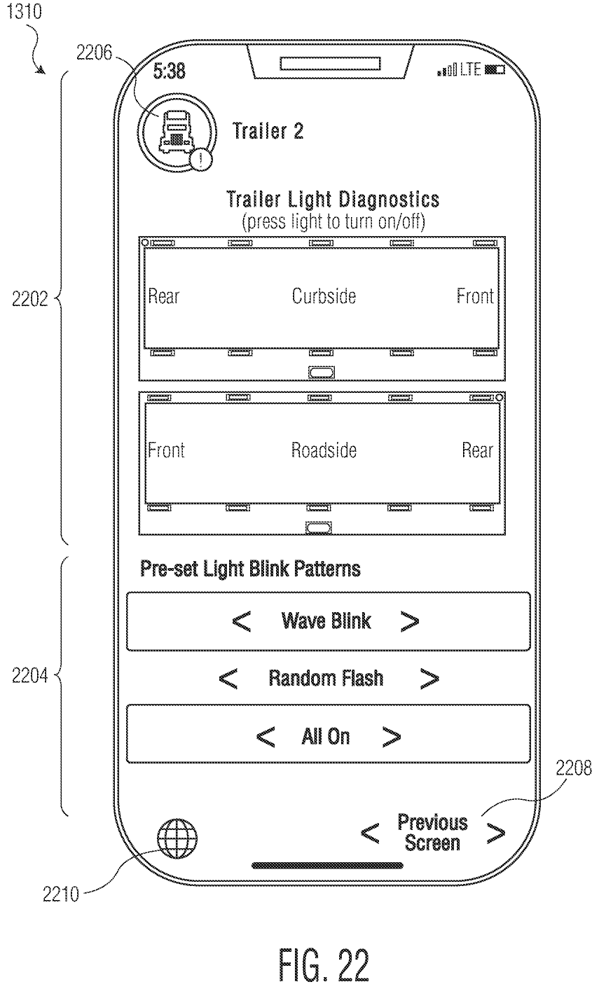

Referring now to FIG. 22, the trailer fault detail action view 1310 for the light diagnostics prompt 2110 is shown. The trailer fault detail action view 1310 may include an identity of the trailer 2206, a first area 2202, and a second area 2204. The first area 2202 may show a graphical illustration of the trailer and the external lights. For example, the first area 2202 may show a curbside view of the trailer (labeled front and back) with external lights and a roadside view of the trailer (labeled front and back) with external lights. The user may be able to select individual lights to turn on and off. The second area 2204 may include one or more pre-set light blink patterns that the user can select to troubleshoot problematic lights. For example, the second area may include options to turn on a wave blink, a random flash, or all lights on. The user can return to the trailer fault default view 1308 by selecting a previous screen button 2208. The trailer fault detail action view 1310 may include a globe icon 2210, which can be selected to return to the global view 1304 at any time.

As described above, the smart array of sensors and smart trailer application may allow for the real time monitoring and recording of events related to the performance and structural integrity of the composite panels as well as monitoring their efficacy as insulating material and structural panels. Coupled with software tools and components as well as customizable user interfaces, this system allows for real time monitoring through alerts and access to historical information on the performance of the panel or structure being monitored. In addition to detecting damage such as that caused by impacts, punctures, and dents, the smart array system may include one or more accelerometers that enable the real-time monitoring of one or more of: torsion and twist of the trailer while driving; speed, acceleration, and deceleration of the trailer; collision detection with the frame and undercarriage of the trailer; and determination of driving surface. The smart sensor array may provide static load balance indications, real-time dynamic load balance, and real-time overload warnings through one or more load sensors in the floor of the trailer. One or more temperatures sensors may also be used to create a three dimensional heat map of the interior of trailer to drive cooling and loading efficiencies.

In some examples, the one or more computer systems may include data storage devices storing instructions (e.g., software) for performing any one or more of the functions described herein. Data storage devices may include any suitable non-transitory computer-readable storage medium, including, without being limited to, solid-state memories, optical media and magnetic media.

The term “computer” shall refer to an electronic device or devices, including those specifically configured with capabilities to be utilized in connection with a data conversion and distribution system, such as a device capable of receiving, transmitting, processing and/or using data and information in the particular manner and with the particular characteristics described herein. The computer may include a server, a processor, a microprocessor, a personal computer, such as a laptop, palm PC, desktop or workstation, a network server, a mainframe, an electronic wired or wireless device, such as for example, a telephone, a cellular telephone, a personal digital assistant, a smartphone, an interactive television, such as for example, a television adapted to be connected to the Internet or an electronic device adapted for use with a television, an electronic pager or any other computing and/or communication device specifically configured to perform one or more functions described herein.

The term “network” shall refer to any type of network or networks, including those capable of being utilized in connection with a data conversion and distribution system described herein, such as, for example, any public and/or private networks, including, for instance, the Internet, an intranet, or an extranet, any wired or wireless networks or combinations thereof.

The term “user interface” shall refer to any suitable type of device, connection, display and/or system through which information may be conveyed to and received from a user, such as, without limitation, a monitor, a computer, a graphical user interface, a terminal, a screen, a keyboard, a touchscreen, a biometric input device that may include a microphone and/or camera, a telephone, a personal digital assistant, a smartphone, or an interactive television.

The term “computer-readable storage medium” should be taken to include a single medium or multiple media that store one or more sets of instructions. The term “computer-readable storage medium” shall also be taken to include any medium that is capable of storing or encoding a set of instructions for execution by the machine and that causes the machine to perform any one or more of the methodologies of the present disclosure.

The term “or” may be construed in an inclusive or exclusive sense. Similarly, the term “for example” may be construed merely to mean an example of something or an exemplar and not necessarily a preferred means of accomplishing a goal.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A structural panel having one or more embedded sensors, the panel comprising:
one or more layers of mesh;
a plurality of first wires woven into the one or more layers of mesh, each of the first wires comprising a loop having:
endpoints located in proximity of a corner of the one or more layers of mesh,
a first portion extending along a first edge of the one or more layers of mesh, and
a second portion extending perpendicular from the first edge across the one or more layers of mesh, wherein the second portions of each of the first wires are separated by a first predetermined distance;
a plurality of second wires woven into the one or more layers of mesh, each of the second wires comprising a loop having:
endpoints located in proximity of the corner of the one or more layers of mesh,
a first portion extending along a second edge of the one or more layers of mesh the second edge perpendicular to the first edge, and
a second portion extending perpendicular from the second edge across the one or more layers of mesh, wherein the second portions of each of the second wires are separated by a second predetermined distance; and
one or more continuity sensors coupled to the endpoints of the first wires and the endpoints of the second wires, the one or more continuity sensors configured to determine a break at a specific point in one or more of the first wires and the wires indicating a location of a puncture of the panel.

2. The panel of claim 1, wherein the first wires comprise rows and the second wires comprise columns, and wherein the one or more continuity sensors can determine a location of the puncture based on a lack of continuity in one or more of the rows and the columns.

3. The panel of claim 1, wherein the first wires and the second wires comprise coated wire having a thickness of approximately 10 gauge, 20 gauge, 30 gauge, to 40 gauge.

4. The panel of claim 1, wherein the first predetermined distance and the second predetermined distance are equal.

5. The panel of claim 1, wherein the one or more layers of mesh comprise a single layer of one or more of a resin, a plastic, and a composite material.

6. The panel of claim 1, wherein the one or more layers of mesh comprise two layers of one or more of a resin, a plastic, and a composite material.

7. A structural panel having one or more integrated sensors, the panel comprising:
a first thermoplastic polymer resin (TPR) layer comprising a first conductive material;
a non-conductive compressive layer on the first thermoplastic polymer resin layer;
a second TPR layer on the non-conductive compressive layer, the second TPR layer comprising a second conductive material;
a printed circuit board (PCB) in the non-conductive compressive layer, the PCB coupled to the first TRP layer and the second TPR layer and configured to measure at least a capacitance across the non-conductive compressive layer such that pressure at a specific point is detected; and
a protective layer on the second TPR layer.

8. The panel of claim 7, wherein the first TPR layer and the second TPR layer comprise polyethylene terephthalate (PET).

9. The panel of claim 7, wherein the non-conductive compressive layer comprises a foam insulator.

10. The panel of claim 7, wherein the PCB is coupled to the first TRP layer and the second TPR layer via one or more zero insertion force (ZIF) connectors.

11. The panel of claim 7, wherein the PCB is further configured to measure one or more of acceleration and temperature.

12. The panel of claim 7, wherein the PCB is further configured to communicate data to a processing gateway via one or more cables.

13. The panel of claim 7, wherein the PCB is further configured to communicate with one or more adjacent PCBs in one or more adjacent panels via one or more cables.

14. The panel of claim 7, wherein the PCB is located in a corner of the non-conductive compressive layer such that a connector of the PCB is exposed.

15. A system of structural panels having one or more integrated sensors, the system comprising:
an array of panels arranged to form a continuous surface, each panel electrically connected to at least one adjacent panel via one or more cables, each panel comprising:
a first thermoplastic polymer resin (TPR) layer comprising a first conductive material,
a non-conductive compressive layer on the first thermoplastic polymer resin layer,
a second TPR layer on the non-conductive compressive layer, the second TPR layer comprising a second conductive material,
a printed circuit board (PCB) in the non-conductive compressive layer, the PCB coupled to the first TRP layer and the second TPR layer and configured to measure at least a capacitance across the non-conductive compressive layer such that pressure at a specific point is detected, and
a protective layer on the second TPR layer; and
a processing gateway coupled to each PCB via one or more cables, the processing gateway configured to wirelessly transmit data received from each PCB to a remote server.

16. The system of claim 15, wherein the first TPR layer and the second TPR layer comprise Polyethylene terephthalate (PET).

17. The system of claim 15, wherein the non-conductive compressive layer comprises a foam insulator.

18. The system of claim 15, wherein the PCB is coupled to the first TRP layer and the second TPR layer via one or more zero insertion force (ZIF) connectors.

19. The system of claim 15, wherein the PCB is further configured to measure one or more of acceleration and temperature.

20. The system of claim 15, wherein the PCB of each panel in the array of panels is further configured to communicate with one or more adjacent PCBs in one or more adjacent panels via one or more cables.

21. The system of claim 15, wherein the PCB is located in a corner of the non-conductive compressive layer such that a connector of the PCB is exposed.
